(19) United States
(12) Patent Application Publication
(10) Pub. No.: US 2017/0132314 A1
(43) Pub. Date: May 11, 2017

(54) IDENTIFYING RELEVANT TOPICS FOR RECOMMENDING A RESOURCE

(71) Applicant: Hewlett-Packard Development Company, L.P., Fort Collins, CO (US)

(72) Inventors: Lei LIU, Palo Alto, CA (US); Georgia Koutrika, Palo Alto, CA (US); Jerry Liu, Palo Alto, CA (US); Steven J. Simske, Ft. Collins, CO (US)

(21) Appl. No.: 15/315,948

(22) PCT Filed: Jun. 2, 2014
(86) PCT No.: PCT/US2014/040566

§ 371 Date: Dec. 2, 2016

(51) Int. Cl. G06F 17/30; G06F 17/27

(52) U.S. Cl. CPC G06F 17/30687; G06F 17/30696; G06F 17/2785; G06F 17/241

(57) ABSTRACT

Examples herein disclose identifying multiple topics within a selected passage. The examples disclose processing the multiple topics in accordance with a statistical model to determine relevant topics to the selected passage. Additionally, the examples disclose outputting a resource related to the relevant topics.

### BACKGROUND

Electronic learning may include the use of electronic media, such as electronic books and other electronic publications to deliver text, audio, images, animations, and/or videos. As such, a student may interact with the media to engage in the exchange of information and/or ideas.

### BRIEF DESCRIPTION OF THE DRAWINGS

In the accompanying drawings, like numerals refer to like components or blocks. The following detailed description references the drawings, wherein:

FIG. 1 is a block diagram of an example system include a computing device in which a passage is selected and passed onto a processing module to identify multiple topics, a topic module determines a probability of relevance for each of the multiple topics for identifying relevant topics, and a recommendation module determines a resourced related to the relevant topics for output to the computing device;

FIG. 2A is a block diagram of an example system including a selected passage as input into a processing module to determine relevant topics in which a resource module identifies multiple resources and a recommendation module ranks the multiple resources for display;

FIG. 2B is a block diagram of an example selected passage for processing each of the multiple topics to determine the probability of relevance of each topic to the selected passage;

FIG. 3 is an illustration of an example display in which a user selects a passage and a type of resource and in turn, receives multiple resources related to relevant topics in the selected passage;

FIG. 4 is a flowchart of an example method to process a selected passage for identifying relevant topics from multiple topics in accordance with statistical analysis model and recommend one or more resources related to the relevant topics;

FIG. 5 is a flowchart of an example method to receive a selected passage with multiple topics for processing and in turn identifying relevant topics from the multiple topics in accordance with a statistical analysis model by determining a probability of relevance for each of the multiple topics, and retrieving multiple resources related to the relevant topics for recommending one or more resources;

FIG. 6 is a flowchart of an example method to process a selected passage in accordance with a topic model to identify relevant topics from multiple topics within the selected passage, the method may proceed to recommend a resource to the relevant topics; and

FIG. 7 is a block diagram of an example computing device with a processor to execute instructions in a machine-readable storage medium for processing a selected passage in accordance with a topic model to identify relevant topics among multiple topics and to recommend a resource among multiple resources.

### DETAILED DESCRIPTION

In electronic learning environments, when a user has difficulty understanding a part of electronic text, such as a passage, they may want find learning resources to help them understand. Electronic text is a medium of communication that represents natural language through signs, symbols, characters, etc. Electronic text may include text, one or more words, and/or one or more terms. As such, the terminology of text, words, and terms maybe used interchangeably throughout this document.

One strategy is to treat the whole unclear passage as a query and submit to a search engine; however this may generate an error as search engines may be designed to accept a few words rather than a full passage as the query. Another strategy is to manually select the few words within the passage to form the query and submit to the search engine. This is inefficient and unreliable as the user may not understand the content in the passage. Additionally, search engines may transform the query and words into vectors of words, thus topics underlying the content within the passage may be overlooked.

To address these issues, examples disclosed herein facilitate the learning process by enabling a search function for selected passages within an electronic document. In one example, the selected passage may be longer in length, such as a paragraph or longer and treated as a query to retrieve the most related resources to the selected passage.

The examples disclosed herein process the selected passage in accordance with a topic model to generate multiple topics. Upon generating the multiple topics, each of the topics may be assigned a probability of relevance. The probability of relevance provides a mechanism in which the relevant topics may be identified from the multiple topics. Identifying the relevant topics provides the means in which to retrieve multiple resources that are relevant to the selected passage. The multiple resources may include a set of web documents, video, and/or images that are related to the selected passage which may provide additional assistance to the user in understanding the content of the selected passage. In this manner, one or more of these multiple resources may be recommended to the user given the underlying topic information obtained from the selected passage. This further aids the user in fully understanding the underlying content to the selected passage.

Additionally, the examples disclose retrieving multiple resources from a search engine and/or database. Each of the multiple resources may be given a relevance score indicating how related a particular resource is to the selected passage. Assigning the relevance score provides a ranking system to determine the most relevant resources to provide to the user. The ranking system provides an approach to determine the most relevant resource to the least relevant. Thus, the most relevant resources may be recommended to the user.

In summary, examples disclosed herein facilitate the learning process through a user selecting a passage and recommending one more resources as related to the selected passage.

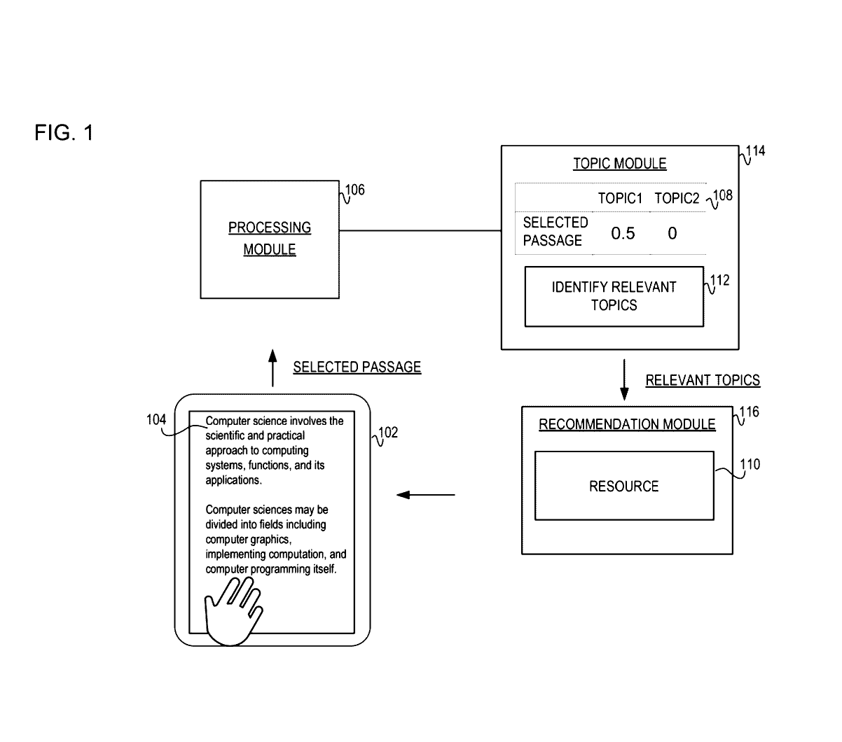

Referring now to the figures, FIG. 1 is a block diagram of an example system including computing device 102 on which a user may select a passage 104. A processing module 106 receives the selected passage 104. Upon processing the selected passage 104, a topic module 114 may receive the processed selected passage 104 for identifying multiple topics in accordance with a statistical model, such as a topic model. Upon identifying the multiple topics, the topic module 114 utilizes the topic model to determine a probability of relevance 108 for each of the multiple topics to identify relevant topics from the multiple topics at module 112. A recommendation module 116 receives the relevant topics and retrieves a resource 110 related to the relevant topics for recommending to the user. FIG. 1 illustrates a system which allows the user to obtain more information on underlying topics within the selected passage 104. In one implementation, the computing device 102 communicates to a server to transmit the selected passage 104 for processing, while in another implementation, a controller operating on the computing device 102 processes the selected passage 104 in a background process to recommend one or more resources 110 to the user. In another implementation, the modules 106, 114, and 116 are considered part of an algorithm executable by the computing device 102.

The computing device 102 is an electronic device and as such, may include a display for the user to select the passage 104 and present the resource to the user. As such, implementations of the computing device 102 include mobile device, client device, personal computer, desktop computer, laptop, tablet, video game console, or other type of electronic device capable of enabling the user to select the passage 104.

The selected passage 104 may include electronic text and/or visuals from within an electronic document that the user may be reading. As such, the user may select the passage 104 which is used as input to the system to recommend one or more resources 110 as relevant to the selected passage 104. In one implementation, the selected passage 104 may be at least a paragraph long of text, thus providing a longer query as input to the system. The user may select specific passages from the electronic document to understand more about underlying topics within the selected passage. In this regard, the system in FIG. 1 aids the user in understanding more about the selected passage 104.

The processing module 106 receives the selected passage 104 upon the user selecting the passage. In one implementation, the processing module 106 performs a pre-processing on the selected passage 104. Pre-processing includes removing stop words, performing stemming, and/or removing redundant words from the selected passage 104. Upon pre-processing, the selected passage 104 may be passed to the topic module 114 for identifying relevant topics among multiple topics. Implementations of the processing module 106 may include an instruction, set of instructions, process, operation, logic, technique, function, firmware, and/or software executable by a computing device for receiving the selected passage 104.

The topic module 114 is considered a topic generator module which identifies relevant topics at module 112 based on the probabilities of relevance 108 for each of the multiple topics. The topic module 114 is responsible for generating the multiple topics which may encompass many of the various underlying abstract ideas within the selected passage 104. In one implementation, the topic module may utilize the topic module to generate the multiple topics. In this implementation, given the selected passage 104 as the longer query, the topic model is used to discover the multiple topics underlying the selected passage 104. The idea behind the topic model is when the selected passage 104 is about a particular topic, some words appear more frequently than others. Thus, the selected passage 104 is mixture of topics, where each topic is a probability distribution over words. For example, given the selected passage 104 is about one or more topics, particular words may appear more or less frequently in the selected passage 104. Thus by identifying particular words which may appear more often in the selected passage 104, the multiple topics may be discovered. The topic model may be discussed in a later figure. Implementations of the topic module 114 may include an instruction, set of instructions, process, operation, logic, technique, function, firmware, and/or software executable by a computing device capable of processing the selected passage 104 to identify the relevant topics.

The probabilities of relevance 108 provide a statistical analysis to indicate how relevant the particular topic is to the selected passage 104. Since the selected passage 104 may include various topics and mixtures of words, the probabilities of relevance 108 to the selected passage may be calculated for determining the likelihood a particular topic is relevant to the selected passage 104. In this regard, the probability of relevance 108 is used to quantify how likely a given topic is relevant to the underlying context of the selected passage 104. The higher a value of probability 108 for the given topic, the more likely that given topic is relevant to the selected passage 104. The probabilities of relevance provide a ranking system to determine which of the topics may be highly relevant to the selected passage 104 to cover the underlying context. For example in FIG. 1, topic 1 is considered more relevant to the selected passage 104 than topic 2.

At module 112, the topic module 114 identifies the relevant topics from the multiple topics. In one implementation, module 112 includes determining which of the topics have a higher probability of relevance 208. In another implementation, a number of relevant topics may pre-defined beforehand to enable an efficient retrieval of the related resource 110. In another implementation, module 112 determines which of the topics have a higher probability of relevance 208 based on pre-defined user attributes and/or from other sources that may infer the user's preference. For example, one user may be more interested in particular topics, thus the higher probability 208 function may take this into account to assign a weightier value to these topics. Implementations of the module 112 include an instruction, set of instructions, process, operation, logic, technique, function, firmware, and/or software executable by a computing device to identify the relevant topics.

The recommendation module 116 uses the identified relevant topics at module 112 to retrieve one or more resources 110 for recommending to the user. In one implementation, the recommendation module 116 retrieves multiple resources from a search engine and/or database and performs a selection process to recommend the most related resources. In this implementation, the recommendation module 116 may include a relevance score for each of the multiple resources to indicate which of the multiple resources to recommend. Implementations of the recommendation module 116 may include an instruction, set of instructions, process, operation, logic, technique, function, firmware, and/or software executable by a computing device capable of retrieving multiple resources and determine which of the multiple resources to recommend to the user.

The resource 110 is a learning instrument which may help the user understand or learn more about underlying topics to the selected passage 104. As such, the resource 110 is considered connected to the selected passage 104 in the sense the resource 110 helps provide additional clarification and/or expertise to the selected passage 104. The resource 110 may include a combination of text, video, images, and/or Internet links that are related to the relevant topics identified at module 112. For example, the resource 110 may include a portion of an article of one of the underlying topics and/or video. Although FIG. 1 illustrates the resource 110 as a single element, implementations should not be limited as the resource 110 may include multiple resources for recommending to the user.

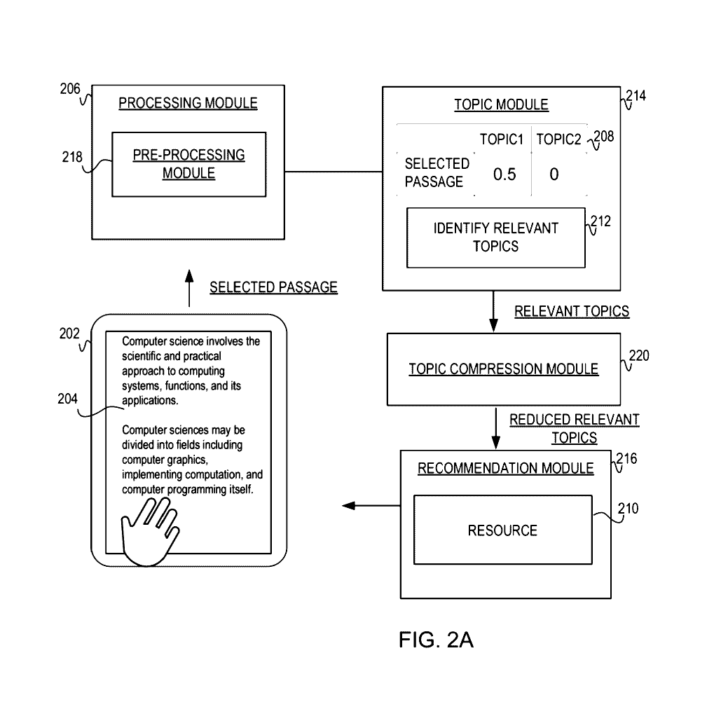

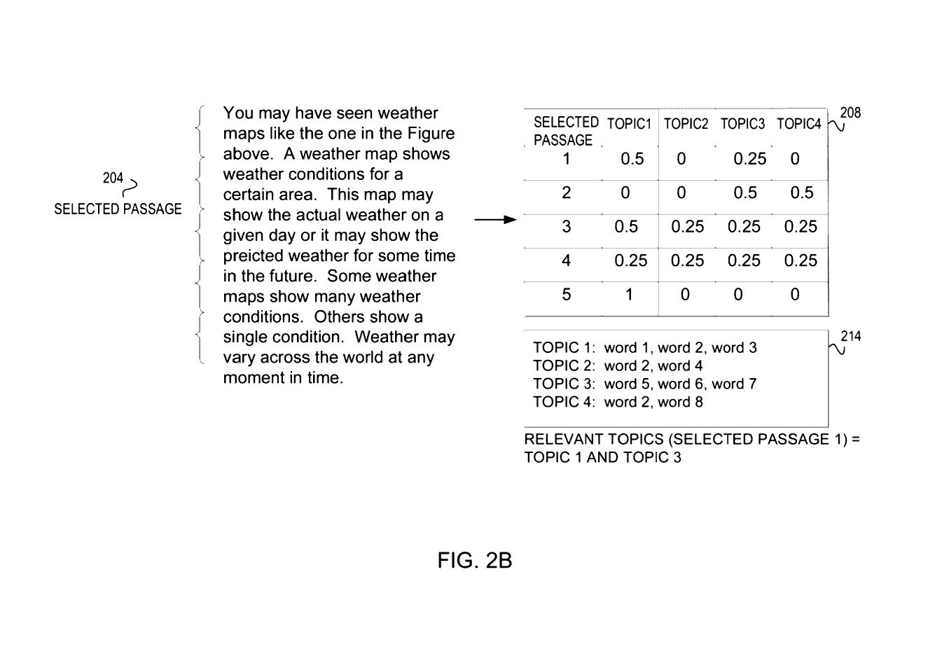

FIG. 2A is a block diagram of an example system including a computing device 202 with a selected passage 204 as input to a processing module 206. The processing module 206 includes a pre-processing module 218 which pre-processes the selected passage to remove stop words and/or redundant words from the selected passage 204. A topic module 214 receives the pre-processed selected passage 204 for identifying multiple topics and relevant topics from the multiple topics at module 212. The topic module 208 identifies the relevant topics by calculating a probability of relevance 208 for each of the multiple topics within the pre-processed selected passage. A topic compression module 220 receives the identified relevant topics and reduces a number of the relevant topics prior to transmission to a recommendation module 216. The recommendation module 216 uses the reduced number of relevant topics to retrieve multiple resources from a database and/or search engine. The recommendation module 216 may further rank each of the multiple topics by calculating a relevance score for each of the multiple topics. Using the relevance scores, the recommendation module 216 may select one or more resources 110 which should be recommended to the user. The computing device 202 and the selected passage 204 may be similar in structure and functionality to the computing device 102 and the selected passage 104 as in FIG. 1.

The processing module 206 receives the selected passage 204 as input and as such includes the pre-processing module 218 to filter out particular words from the selected passage 204. This provides a shortened or reduced version of text to save space and increase a speed for identifying the multiple topics from the selected passage 204. The pre-processing module 218 filters out text by removing stop words, noisy words, and/or redundant words from the selected passage 204. Additionally, the pre-processing module 218 may perform stemming on the text within the selected passage 204 prior to handing off to the topic module 214. Stop words are filtered out prior to processing the natural language text of the selected passage 204 at the topic module 214. Such stop words may include: which, the, is, at, on, a, and, an, etc. Stemming includes the process for reducing inflected words to their stem or root form. For example, the “catty,” and catlike,” may be based on the root of “cat.” The processing module 206 may be similar in functionality to the processing module 106 as in FIG. 1. Implementations of the pre-processing module 218 include an instruction, set of instructions, process, operation, logic, technique, function, firmware, and/or software executable by a computing device capable of reducing text within the selected passage 204.

The topic module 214 receives the pre-processed selected passage and in accordance with a statistical analysis model, such as a topic model, the topic module 214 discovers abstract topics underlying the pre-processed selected passage. For example, given the pre-processed selected passage as a query, the topic model may be used to identify the multiple topics as particular words may appear in each topic more or less frequently together. Upon generating the multiple topics, each topic may be represented by a set of words that frequently occur together. Examples of the topic models may include a probabilistic latent semantic indexing and latent dirichlet allocation. In this example, the topic module 214 may generate the probability of relevance value 208 to capture the probability that the set of words within the pre-processed selected passage covers the corresponding topic. For example, assume the set of words include, “animal,” “pet,” “bone,” “tail,” indicates one of the multiple topics includes a topic within the pre-processed selected passage concerns a dog. In another example, assume the set of words include, “whiskers,” “pet,” “independent,” may indicate the other topic concerns a cat. Thus, the probability of relevance 208 for each of the topics may include a probability of distribution over the sets of words. As illustrated in FIG. 2A, the probability of relevance 208 for the first topic concerning the dog is higher than the second topic, the cat. This indicates the first topic is the more relevant topic as words corresponding to dog may more frequently appear in the pre-processed selected passage. Assigning the probability of distribution 208 to each of the multiple topics (Topic 1, Topic 2) enables the topic module 214 to identify the more relevant topics to the preprocessed selected passage as at module 212. The topic module 214, the probability of relevance 208, and module 212 is similar in functionality to the topic module 114, the probability of relevance 108, and the module 112 as in FIG. 1.

Upon identifying the relevant topics at module 212, the relevant topics may be compressed by the topic compression module 220. It may be possible that the relevant topics identified at module 212 are associated with similar concepts. To remove such redundancy, the relevant topics may be reduced to create the reduced number of relevant topics to pass onto the recommendation module 216. One example to reduce the number of relevant topics would be to consider the word distribution for each of the multiple topics, and then remove duplicate topics if both are discussing similar topics. To determine whether both of the multiple topics are about similar concepts, a correlation function such as a Pearson correlation may be used. Another example to reduce the number of relevant topics includes taking into account the probabilities of relevance 208 and pruning topics that fall below a particular probability threshold. This eliminates topics that may be considered statistically unimportant. Implementations of the topic compression module 220 include an instruction, set of instructions, process, operation, logic, technique, function, firmware, and/or software executable by a computing device capable obtaining the reduced number of relevant topics.

The recommendation module 216 receives the reduced number of relevant topics from the topic compression module 220 and retrieves multiple resources related to the reduced number of relevant topics from a database and/or search engine. In this implementation, each of the relevant topics reduced at module 220 is used to search for the top most relevant resources. In this implementation, each of reduced number of relevant topics includes multiple resources with each set of resources corresponding to the particular relevant topic may be treated as a content bucket. Then each bucket generates a set of topics as the semantic features with topic generation discussed above. In another implementation, the recommendation module 216 calculates a relevance score for each of the multiple resources as each related to the corresponding topic detected from the selected passage 204. This may capture explicit similarity between each of these topics and each of the retrieved multiple resources. In this implementation, each topic feature generated for each content bucket may be compared to the selected passage 204. For example, a similarity or distance function may be used such as cosine similarity and/or Euclidean function, etc. Other implementations may analyze links within the selected passage 204 and/or each of the multiple resources, while further implementations analyze the co-citation information in each of the multiple resources. Calculating the relevance score for each of the multiple resource, enables a ranking system for each of the multiple resources. The ranking system provides values for the recommendation module 216 to determine which of the multiple resources should be recommended to the user for display at the computing device 202. Additionally, the relevance score provides a type of closeness score to ensure the most related of the multiple resources are provided to the computing device 202. The recommendation module 216 may be similar in functionality to the recommendation module 116 as in FIG. 1. The resource 210 may be similar in structure and functionality to the resource 110 as in FIG. 1.

FIG. 2B is a block diagram of an example selected passage 204 processed in accordance to a topic model. The selected passage 204 is processed to generate multiple topics (Topic 1, Topic 2, Topic 3, Topic 4, and Topic 5) by associating a set of words 214 to identify the multiple topics. A probability of relevance is assigned for each of the multiple topics to indicate how relevant a given topic is to a particular selected passage. In this manner, the relevant topics may be identified from the multiple topics. For example, topics with a value above a particular threshold may be identified as one of the relevant topics.

Given the selected passage 204 as a query, the topic model is used to discover the multiple topics underlying the selected passage 204. Examples of the topic model may include probabilistic semantic indexing and/or latent dirichlet allocation. The idea behind the topic model is when the selected passage 204 is about a particular topic, some words appear more frequently than others. Thus, the selected passage 204 is mixture of topics, where each topic is a probability distribution over words. For example, given the selected passage 204 is about one or more topics, particular words may appear more or less frequently in the selected passage 204. The selected passage 204 is represented as selected passage 1 in a topic matrix 208. The other selected passages (not illustrated) are represented as selected passages 2-4 in the topic matrix 208.

Upon identifying the multiple topics, each topic may be associated with a set of words 214 that may frequently occur together. The set of words 214 represent a context of the particular topic and as such, the set of words 214 is used to scan the selected passage 204 to determine the probability of relevance for the sets of words in the selected passage. For example, each of the topics is associated with two or more words (word 1-word 8). Although FIG. 2B illustrates each of the topics as associated with an independent set of words, this was done for illustration purposes. For example one or more of the words (word 2) may overlap in association with other topics.

In one implementation, upon processing the selected passage 204 to remove stop words and redundant words, a topic is created. In this implementation, a word matrix is generated and used as input to the topic model and the output to the topic model is the topic matrix. A value in this matrix captures the probability score a selected passage (Selected Passages 1-5) covers a particular topic (Topics 1-4). The probability score 208 is the probability of relevance indicating the likelihood of relevance for each topic to the selected passage 204. The probability of relevance 208 enables each of the multiple topics to be assigned a value which may indicate its statistical relevance to the selected passage 204. The higher the value, the more likely that particular multiple topic is considered one of the relevant topics to the selected passage 204. This enables a list of the multiple topics to be pruned down to identify the relevant topics. The relevant topics may be used to recommend one or more multiple resources to the user. For example, for the selected passage 204 (Selected Passage 1), the higher values of probabilities are listed for Topic 1 and Topic 3, thus the relevant topics.

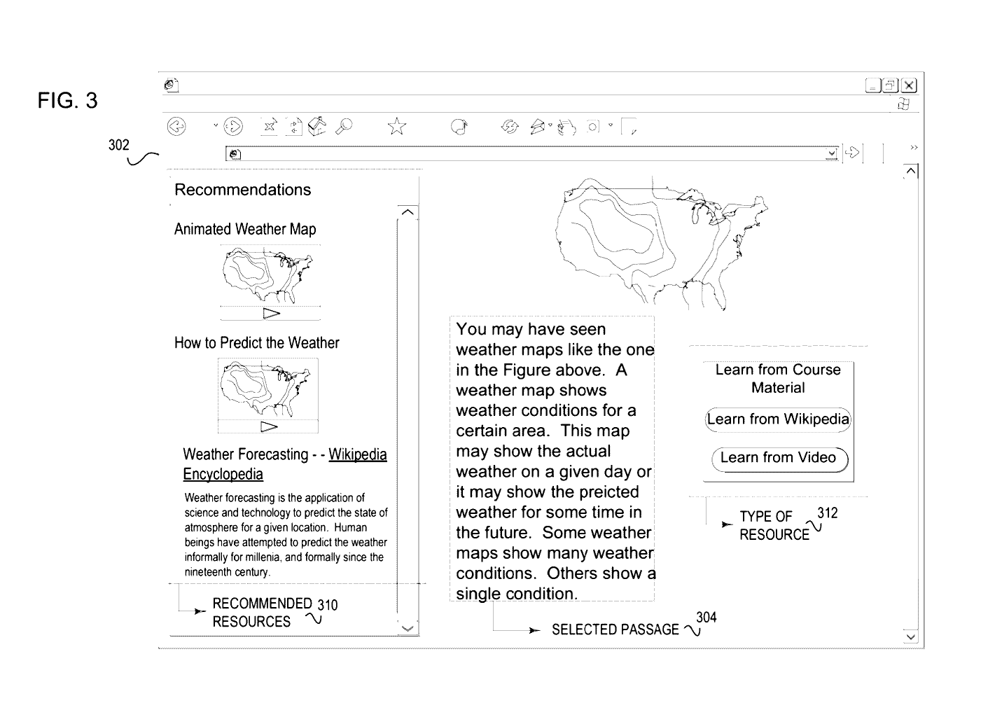

FIG. 3 is an illustration of an example display on a computing device 302 in which a user selects a passage and receives one or more recommended resources 310 in return. Additionally, the user may also select a type of resource 312. The type of resource 312 indicates how the user may desire in how to receive the recommended results 310. The user selects the passage 304 and the type of resource 312 from the display. The computing device 302 operates in a background type process to receive the selected passage 304 and type of resource selection 312. The computing device 302 processes the selected passage 304 in accordance with a statistical model, such as a topic model, to generate multiple topics from the selected passage 304. Upon generating the multiple topics from the selected passage 304, the computing device 302 whittles a list of the multiple topics to identify relevant topics. The relevant topics are used to retrieve multiple resources as potential recommended resources. The recommended resources 310 may be selected from the multiple resources in accordance with the selected type of resource 312 and/or relevance score which is described in a later figure. The computing device 302, the selected passage 304, and the recommended resources 310 may be similar in structure and functionality to the computing device 102 and 202, the selected passage 104 and 204, and the resource 110 and 210 as in FIGS. 1-2. Although FIG. 3 represents the recommended resources 312 as a combination of text and/or videos, this was done for illustration purposes and not for limiting the recommended resources 312. For example, the recommended resources 312 may include a combination of one or more Internet links, text, video, and/or images.

The type of resource 312 represents how the user may want to receive the recommended resources 310. For example in FIG. 3, both YouTube and Wikipedia are selected, representing the type of recommended resources 310 including both text and video. Although FIG. 3 represents the type of resource 312 as from course material, Wikipedia, and YouTube this was done for illustration purposes and not for limiting implementations. For example, the type of resources 312 may include video, audio, image, and/or text.

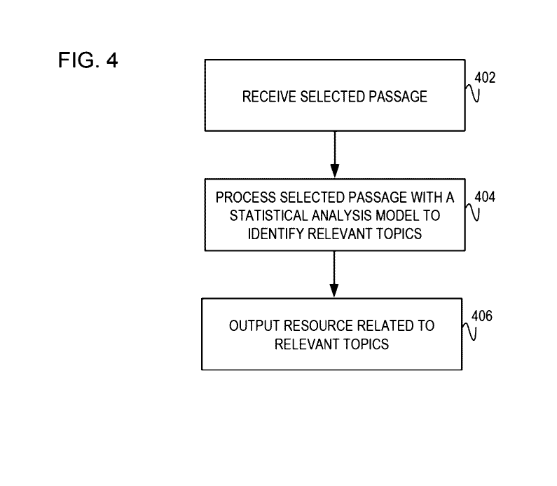

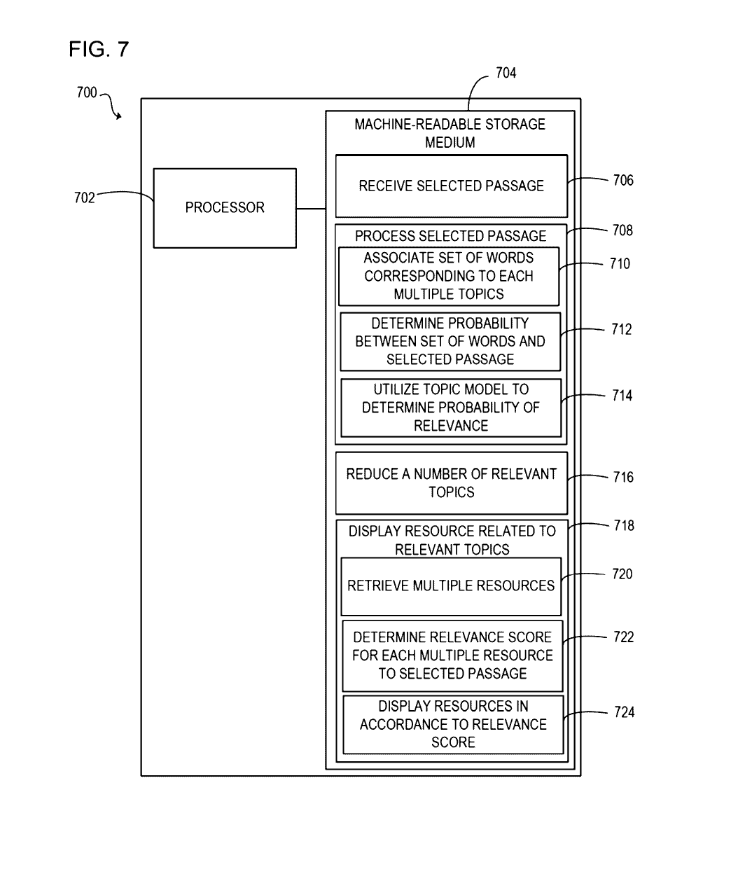

FIG. 4 is a flowchart of an example method to receive a selected passage and process the selected passage in accordance with a statistical model. Processing the selected passage in accordance with the statistical model enables relevant topics to be identified among multiple topics within the selected passage. Identifying the relevant topics among the multiple topics, the method may proceed to recommend one or more resources as related to the relevant topics. Each of the operations 402-406 may be executable by a controller and/or computing device 102 as in FIG. 1. As such, implementations of operations 402-406 include a process, operation, logic, technique, function, firmware, and/or software executable by the controller and/or computing device. In discussing FIG. 4, references may be made to the components in FIGS. 1-3 to provide contextual examples. In one implementation of FIG. 4, the controller is associated with the computing device 102 as in FIG. 1 to perform operations 402-406. In this implementation, the operations 402-406 may operate as a background process on the computing device upon receiving the selected passage. In another implementation, a server may communicate with the computing device 102 to perform operations 402-406. Further, although FIG. 4 is described as implemented by the computing device 102, it may be executed on other suitable components. For example, FIG. 4 may be implemented by a processor (not illustrated) or in the form of executable instructions on a machine-readable storage medium 704 as in FIG. 7.

At operation 402, the controller may receive the selected passage. A passage may include electronic text as part of an electronic document or electronic publication from which a user may select to learn and/or understand more about the topic(s) within the selected passage. The selected passage encompasses multiple topics which may indicate one or more underlying concepts. In one implementation, operation 402 may include pre-processing the selected passage. Pre-processing may include removing stop words, performing stemming, and/or removing redundant words from the selected passage. This implementation may be discussed in detail in the next figure. Upon receiving the selected passage, the method may proceed to operation 404 for processing the selected passage in accordance with the statistical model for identifying the multiple topics.

At operation 404, the controller processes the selected passage received at operation 402 to identify the relevant topics. At operation 404, an algorithm as executed by the controller, may analyze words occurring in the selected passage to discover the multiple topics within the selected passage. In this implementation, operation 404 may identify multiple topics within the selected passage by determining which words appear more or less frequently. For example in this implementation, a topic modeling program may be executed by the controller to analyze words occurring in the selected passage. The idea behind the topic model algorithm is when the selected passage is about a particular topic, some words appear more frequently than others. Thus, the selected passage is mixture of topics, where each topic is a probability distribution over words. As explained earlier, the multiple topics may indicate one or more underlying concepts within the selected passage. As such, the topics may be identified through determining particular words which may appear more or less frequently. For example, the underlying concept may include “weather map,” thus the topic may include “weather,” and “map.” In another implementation of operation 404, each of the multiple topics is associated with a set of words to represent the concept of the topic. In this implementation, the set of words is analyzed to determine which how frequently particular words are used within the selected passage, thus enabling the identification of the relevant topics. The relevant topics are a subset of the multiple topics which may be considered the most relevant of the multiple topics to the selected passage. Each of the multiple topics may be analyzed through associated terms to calculate a probability of relevance for each multiple topic to the selected passage. The probability of relevance is a value indicating the likelihood of relevance for each topic to the selected passage. The probability of relevance enables each multiple topic to be assigned a value which may indicate its statistical relevance to the selected passage. The relevant topics may be used to retrieve multiple resources for recommending one or more of these multiple resources as at operation 406.

At operation 406, the controller recommends the resource related to the relevant topics identified at operation 404. Upon the recommendation, the resource may be displayed on the computing device to the user. In one implementation, the controller may retrieve multiple resources and select which of the multiple resources should be recommended to the user. The controller selects the final resources which may be considered the most relevant to the underlying context to the selected passage. In another implementation, multiple resources may be retrieved utilizing the search engine and/or database. In this implementation, each of the multiple resources may be given a relevance score for ranking each of the multiple resources in order of the most relevant to least relevant. The controller may then select the most relevant of the multiple resources for recommending to the user. This implementation may be discussed in a later figure. In a further implementation, the user may select the number of resources for recommendations.

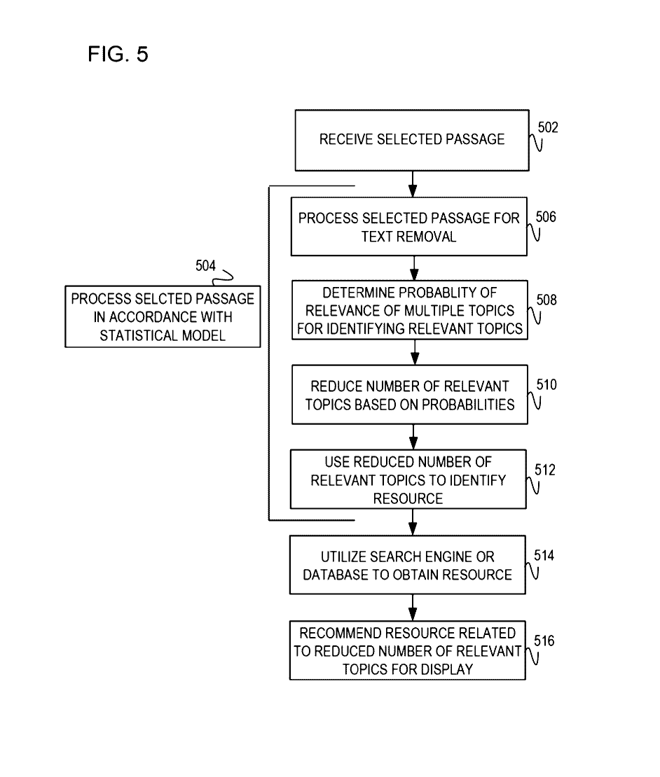

FIG. 5 is a flowchart of an example method to identify relevant topics from multiple topics within a selected passage and retrieve one or more resources related to the relevant topics for display. FIG. 5 illustrates how the relevant topics may be reduced based on the probability of relevance for identifying the relevant topics from the multiple topics. Each of the operations 502-516 may be executable by a controller and/or computing device 102 as in FIG. 1. As such, implementations of operations 502-516 include a process, operation, logic, technique, function, firmware, and/or software executable by the controller and/or computing device. In discussing FIG. 5, references may be made to the components in FIGS. 1-3 to provide contextual examples. In one implementation of FIG. 5, the controller is associated with the computing device 102 as in FIG. 1 to perform operations 502-516. In this implementation, the operations 502-516 may operate as a background process on the computing device upon receiving the selected passage. In another implementation, a server may communicate with the computing device 102 to perform operations 502-516. Further, although FIG. 5 is described as implemented by the computing device 102, it may be executed on other suitable components. For example, FIG. 5 may be implemented by a processor (not illustrated) or in the form of executable instructions on a machine-readable storage medium 704 as in FIG. 7.

Operation 502, the controller receives the selected passage. A passage may include electronic text as part of an electronic document or electronic publication from which a user may select to learn and/or understand more about the topic(s) within the selected passage. The multiple topics may indicate one or more underlying concepts within the selected passage. As such, the topics may be identified through determining particular words which may appear more or less frequently as at operation 504. Operation 502 may be similar in functionality to operation 402 as in FIG. 4.

Operation 504, the controller processes the selected passage in accordance with the statistical model. Processing the selected passage, enables the controller to identify the multiple topics of the selected passage. Upon identifying each of the multiple topics, the controller may further identify the relevant topics from the multiple topics. This shortens a list of topics in which the controller may retrieve recommended results. In one implementation, the controller processes the selected passage in accordance with a topic model. For example, the underlying concept of the selected passage may include “weather map,” thus the topic may include “weather,” and “map.” In another implementation, each of the topics is associated with a set of words to represent the concept of the topic. In this implementation, the set of words is analyzed to determine which how frequently particular words are used within the selected passage, thus indicating the more likely relevant topics. This implementation is discussed in detail in the next figure. Processing the selected passage in accordance with the statistical model, provides a clear path for the controller to trim a list of multiple topics from the most relevant to the least relevant to the selected passage. Trimming the list ensures the most relevant resources are recommended to the user. Operation 504 may be similar in functionality to operation 404 as in FIG. 4.

Operation 506, the controller processes the selected passage for text removal. Operation 506 may include removing stop words, performing stemming, and/or removing redundant words. For example, operation 506 includes removing stop words from the selected passage such as “a,”, “and,” “an,” “the,” etc. In another example, operation 506 may also include stemming which includes the process for reducing inflected words to their stem or root form. For example, the “catty,” and catlike,” may be based on the root of “cat.” In yet another example, operation 506 may include removing redundant words.

Operation 508, the controller determines a probability of relevance for each of the multiple topics identified from the selected passage at operation 502. Since the selected passage may include various topics and mixtures of words, the controller may calculate the probability of relevance to the selected passage for determining the likelihood a particular topic is relevant to the selected passage. In this regard, the probability of relevance is used to quantify how likely a given topic is relevant to the underlying context of the selected passage. Operation 508 enables the relevant topics to be identified from the multiple topics.

Operation 510, the controller reduces the number of relevant topics based on the probabilities of relevance determined at operation 508. As the number of topics identified from the selected passage may be unknown, it may be possible that multiple topics may be identified but are associated with similar concepts. To remove such redundancy, operation 510 may compress the relevant topics, hence reducing the number of relevant topics. In one implementation, word distribution of each of the multiple topics may be considered to determine whether to remove duplicate topics which may both discuss similar concepts. In another implementation, identifying if multiple topics encompass similar concepts, a correlation function, such as a Pearson correlation may be utilized. The correlation function is statistical correlation between random variables at two different points in space in time. In this implementation, the correlation function is used to determine the statistical correlation of the relevant topics to reduce the overall number of topics where may be used as input to retrieve the multiple resources as at operation 512. In yet another implementation to reduce the number of relevant topics, the probabilities of relevance determined at operation 508 may be used to prune those topics which may be statistically unimportant.

Operation 512, the controller may use the reduced number of relevant topics to identify one or more resource. Using the reduced number of relevant topics may prevent similar two or more similar multiple resources from being retrieved. This ensures the multiple resources may be diversified to cover many of the topics within the selected passage.

Operation 514, the controller may utilize a search engine or database to retrieve the multiple resources related to the reduced number of relevant topics. In this implementation, the controller may communicate over a network to retrieve the multiple resources related to the reduced number of relevant topics. Rather than processing the full selected passage, the number of topics is reduced thus enabling the controller to efficiently identify the higher relevant resources for recommendation at operation 516.

Operation 516, the controller may recommend the one or more resources related to the reduced number of relevant topics. The controller may select the final resources which may be recommended to the user. Several factors may be considered in selecting which of the multiple resources to recommend the more representative resources including: how the retrieved multiple resources relate to the full selected passage; the number of resources to select; and how to select the resources which may adequately represent the reduced number of topics without being redundant. In one implementation, multiple resources may be retrieved utilizing the search engine and/or database. In this implementation, each of the multiple resources may be given a relevance score for ranking each of the multiple resources in order of the most relevant to least relevant. The controller may then select the most relevant of the multiple resources for recommending to the user. This implementation may be discussed in a later figure. In another implementation, the user may select the number of resources for recommendations. Operation 516 may be similar in functionality to operation 406 as in FIG. 4.

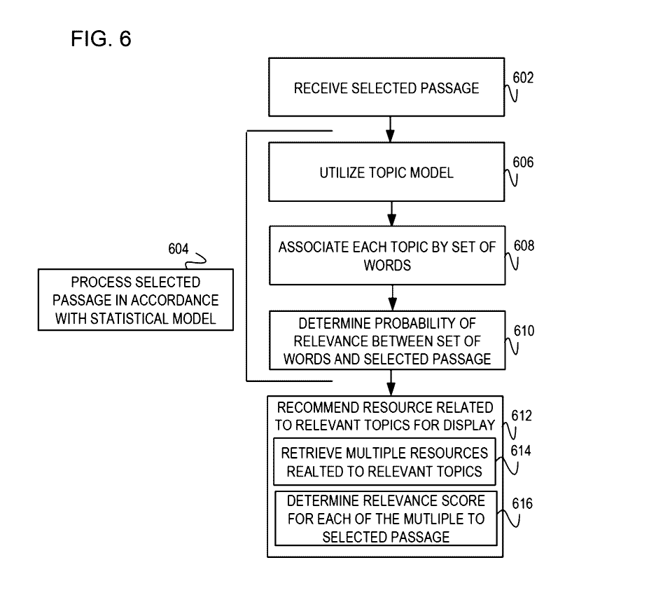

FIG. 6 is a flowchart of an example method to recommend one or more resources related to relevant topics for display. The method processes a selected passage in accordance with statistical model to identify multiple topics within the selected passage. In one implementation, processing the selected passage in accordance with the statistical model. In one implementation, processing the selected passage in accordance with the statistical model may include associating each topic by a set of words and determining a probability of relevance between the set of words and the selected passage. In another implementation, the selected passage is processed in accordance with a topic model. The method processes the selected passage to identify the relevant topics from the multiple topics. Identifying the relevant topics, multiple resources may be retrieved and scored according to the relevance of each of the resources to the selected passage itself. In this manner, one or more resources which may be most relevant to the selected passage may be recommended and displayed to a user. Each of the operations 602-616 may be executable by a controller and/or computing device 102 as in FIG. 1. As such, implementations of operations 602-616 include a process, operation, logic, technique, function, firmware, and/or software executable by the controller and/or computing device. In discussing FIG. 6, references may be made to the components in FIGS. 1-3 to provide contextual examples. In one implementation of FIG. 6, the controller is associated with the computing device 102 as in FIG. 1 to perform operations 602-616. In another implementation, a server may communicate with the computing device 102 to perform operations 602-616. Further, although FIG. 6 is described as implemented by the computing device 102, it may be executed on other suitable components. For example, FIG. 6 may be implemented by a processor (not illustrated) or in the form of executable instructions on a machine-readable storage medium 704 as in FIG. 7.

At operation 602, the controller may receive the selected passage for processing at operation 604. The selected passage is text and/or media as selected by a user, within an electronic document. In one implementation, the selected passage may be at least a paragraph long. This enables the user to obtain the most related or relevant resources to the selected passage to obtain more information about underlying topics within the selected passage. In this manner, the user may receive the most related resources to aid in learning and help the user understand a context of the selected passage. Operation 602 may be similar in functionality to operations 402 and 502 as in FIGS. 4-5.

At operation 604, the controller processes the selected passage in accordance with the statistical model. In one implementation, the computing device processes the selected passage in accordance with the topic model as at operation 606. In another implementation, the computing device processes each of the multiple topics by associating each of the multiple topics with the set of words and determining the probability of relevance for each of the topics by calculating the statistics of each of the sets of words in the selected passage as at operations 608-610. For example, the processing module 104 as in FIG. 1 may receive the selected passage as input and generates multiple topics from the selected passage where each of the multiple topics may indicate a concept underlying the selected passage. The topics may be identified through determining particular words with may appear more or less frequently within the selected passage. For example, the terms “animal,” “pet,” “dog,” and “bone,” may indicate the selected passage concerns dog. Operation 604 may be similar in functionality to operations 404 and 504 as in FIGS. 4-5.

At operation 606, the controller may utilize the topic model to determine the probability of relevance for each of the multiple topics. The topic model is a type of statistical model which identifies abstract topics within the selected passage. Given the selected passage is about one more particular topics, it may be expected that particular words may appear more or less frequently within the selected passage. For example, the words “dog,” and “bone,” may appear more frequently in selected passages about dogs and “cat,” and “meow,” may appear more frequently in selected passages about cats. Thus, the selected passage may concern multiple topics different proportions. For example, the selected passage that may be 80% about dogs, there would probably be eight times more word dogs than cat words. The topic model associates each topic with a set of words and may determine how many times the words may appear in the selected passage, thus indicating an underlying topic. The topic model captures this probability about the topic in a mathematical framework which allows analyzing the selected passage and discovering, based on the statistics of the sets of words in the selected passage, what the topics might be and the probability of the particular topic to the selected passage.

At operation 608, the controller associates each of the multiple topics identified at operation 602 with the set of words that may represent the context of the topic. The set of words represent the context of the topic by giving a meaning fuller or more identifiable as used within the selected passage than if the topic was read in isolation. In one implementation, upon identifying the topic, the controller may retrieve the set of words retrieved from a database. These are terms which may appear more frequently when discussing a specific topic. In another implementation, the controller may extract words from the selected passage that may represent the topic. Thus, the controller may associate these words and analyze the selected passage through the sets of words statistics to determine the relevant topics to the selected passage.

At operation 610, the controller may determine the probability of relevance between each set of words and the selected passage. In one implementation, each word may be analyzed to include a number of times each word is included in the selected passage. In this implementation, a word-matrix is generated where each value of the matrix includes the frequency the particular term or word appears in the selected passage. The value captures the probability that particular word is relevant to the selected passage. In keeping with the previous example, assume the set of words associated with dog may include “tail,” “wag,” “animal,” “pet,” “bone,” “four legs,” etc. Thus, the word-matrix may include higher probabilities values for the terms “bone,” and “wag,” than terms “meow,” and “whiskers.”

At operation 612, the controller may utilize the relevant topics identified at operations 604-610 to recommend the resource. Additionally, the resource may include multiple resources, which may be ranked according to a relevance score to the selected passage, thus these multiple resources may be presented in accordance to the ranking. In one implementation, operation 612 may include displaying and/or presenting the resource on a computing device. In this implementation, operations 602-616 occur in a background of a computing device so the user may select the passage and receive multiple resources to better understand and comprehend underlying topics within the selected passage. In another implementation, operation 612 may include operations 614-616 for obtaining multiple resources and ranking each of the multiple resources prior to outputting the resource related to the relevant topics. Operation 612 may be similar in functionality to operations 406 and 518 as in FIGS. 4-5.

At operation 614, the controller may retrieve multiple resources which are related to the relevant topics. The relevant topics are identified from among the identified topics and used as input to a search engine or database to retrieve the multiple resources related to the relevant topics. Upon retrieving the multiple resources, each of the resources may be given a relevance score such as at operation 616 to limit the number resources which are displayed and/or presented to the user.

At operation 616, the controller may determine a relevance score for each of the multiple resources to the selected passage. In one implementation, each resource may be treated a content bucket in which another set of topics is generated utilizing the topic model as discussed above. Thus, the relevance score may capture the explicit similarity between the content bucket for each of the resources and the selected passage. If there are links within the selected passage and/or the multiple resources, the links may be used to determine the relevance relationship to determine the extent each of the resources and the selected passage are related. Additionally, co-citation information may be used within each of the resources to determine the relevance of the resource to the selected passage. For example, if the resource and the selected passage include a similar co-citation, then the resource may be considered more relevant to the selected passage and receive a higher relevant score. In another implementation, the relevance score may be based on pre-defined user attributes and/or other indicators which may infer the user's preference to the topics. In this implementation, the user attributes and/or preferences may be used to provide a weightier value to these topics. Operation 616 may include ranking each of the multiple resources in order from the most relevant to the selected passage to the least relevant. In this manner, the relevance score indicates which of the multiple resources are the most related to the selected passage. Upon determining the relevance score of each of the multiple resources, the controller may output those resources which are most relevant for display on the computing device.

FIG. 7 is a block diagram of computing device 700 with a processor 702 to execute instructions 706-724 within a machine-readable storage medium 704. Specifically, the computing device 700 with the processor 702 processes a selected passage for identifying multiple topics and determining a probability of relevance for each of the multiple topics for each of the multiple topics. Upon determining the probabilities of relevance, the processor 702 may proceed to identify relevant topics from the multiple topics and use the relevant topics to retrieve multiple resources related to the relevant topics. Upon retrieving the multiple resources, each of the resources may include a relevance score which indicates which resources are for display at the computing device 700. Although the computing device 700 includes processor 702 and machine-readable storage medium 704, it may also include other components that would be suitable to one skilled in the art. For example, the computing device 700 may include a display as part of the computing device 102 as in FIG. 1. The computing device 700 is an electronic device with the processor 702 capable of executing instructions 706-724, and as such embodiments of the computing device 700 include a computing device, mobile device, client device, personal computer, desktop computer, laptop, tablet, video game console, or other type of electronic device capable of executing instructions 706-724. The instructions 706-724 may be implemented as methods, functions, operations, and other processes implemented as machine-readable instructions stored on the storage medium 704, which may be non-transitory, such as hardware storage devices (e.g., random access memory (RAM), read only memory (ROM), erasable programmable ROM, electrically erasable ROM, hard drives, and flash memory.

The processor 702 may fetch, decode, and execute instructions 706-724 to identify relevant topics among multiple topics within the selected passage and recommend a resource related to the relevant topics. In one implementation, upon executing instruction 706, the processor 702 may execute instruction 708 through executing instruction 710-712 and/or instruction 714. In another implementation, upon executing instructions 706-708, the processor 702 may execute instruction 716 prior to executing instruction 718. In a further implementation, upon executing instructions 706-708, the processor 702 may execute instruction 718 through executing instructions 720-724. Specifically, the processor 702 executes instructions 706-714 to: receive the selected passage; process the selected passage by determining the probability of relevance for each of the multiple topics by associating a set of words corresponding to each multiple topic and determining the statistics of each set of words within the selected passage; and/or utilizing a topic model. The processor 702 may execute instruction 716 to reduce a number of relevant topics for retrieving the resource related to the reduced number of topics. Additionally, the processor 702 may execute instructions 718-724 to: display one or more resources related to the relevant topics; retrieve multiple resources from a database and/or search engine; determine a relevance score for each of the multiple resources to display the highest relevant multiple resources.

The machine-readable storage medium 704 includes instructions 706-724 for the processor 702 to fetch, decode, and execute. In another embodiment, the machine-readable storage medium 704 may be an electronic, magnetic, optical, memory, storage, flash-drive, or other physical device that contains or stores executable instructions. Thus, the machine-readable storage medium 704 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 704 may include an application and/or firmware which can be utilized independently and/or in conjunction with the processor 702 to fetch, decode, and/or execute instructions of the machine-readable storage medium 704. The application and/or firmware may be stored on the machine-readable storage medium 704 and/or stored on another location of the computing device 700.

In summary, examples disclosed herein facilitate the learning process through a user selecting a passage and recommending one more resources as related to the selected passage.

We claim:

1. A system comprising:
a processing module to receive a selected passage including multiple topics;
a topic generator module to identify relevant topics from the multiple topics in accordance with a topic model for each of the multiple topics; and
a recommendation module to output a resource related to the relevant topics.

2. The system of claim 1 further comprising:
a topic compression module to:
reduce a number of the relevant topics; and
provide the reduced number of relevant topics to the recommendation module; and
wherein the recommendation module is further to retrieve multiple resources related to the reduced number of relevant topics.

3. The system of claim 2 further comprising wherein the recommendation module is further to:
determine a relevance score for each of the multiple resources and the selected passage; and
select which of the multiple resources should be recommended based on the relevance score.

4. A non-transitory machine-readable storage medium comprising instructions that when executed cause a processor to:
receive a selected passage including multiple topics;
identify the relevant topics from the multiple topics in accordance with a statistical model; and
recommend a resource related to the relevant topics for display.

5. The non-transitory machine-readable storage medium of claim 4 further comprising instructions that when executed by the processor cause the processor to:
reduce a number of the relevant topics through a correlation function to remove redundant concepts among the relevant topics, wherein the resource is related to the reduced number of relevant topics.

6. The non-transitory machine-readable storage medium of claim 4 wherein to recommend the resource related to the relevant topics for display further comprises instructions that when executed by the processor cause the processor to:
retrieve multiple resources related to the relevant topics;
determine a relevance score between each of the multiple resources and the selected passage; and
display at least one of the multiple resources in accordance to the relevance score.

7. The non-transitory machine-readable storage medium of claim 4 wherein to identify the relevant topics from the multiple topics in accordance with the statistical model further comprises instructions that when executed by the processor cause the processor to:
associate each of the multiple topics with a set of words for representing a concept of each of the multiple topics; and
determine a probability of relevance between the set of words and the selected passage.

8. A method comprising:
receiving a selected passage at least a paragraph long;
processing the selected passage in accordance with a statistical analysis model to identify relevant topics from multiple topics within the selected passage; and
recommending a resource related the relevant topics.

9. The method of claim 8 wherein processing the selected passage in accordance with the statistical analysis model to identify the relevant topics comprises:
processing the selected passage to remove at least redundant or stop text from the selected passage;
determining a probability of relevance for each of the multiple topics to the selected passage; and
reducing the multiple topics based on the probability of relevance for each of the multiple topics to identify the relevant topics.

10. The method of claim 8 further comprising:
identifying the resource from a search engine or database.

11. The method of claim 8 wherein processing the multiple topics in accordance with the statistical analysis model further comprises:
utilizing a topic model to determine a probability of relevance for each of the multiple topics to the selected passage.

12. The method of claim 8 wherein the resource is selected from multiple types of resources.

13. The method of claim 8 wherein recommending the resource related the relevant topics comprises:
retrieving multiple resources related to the relevant topics; and
determining a relevance score between each the multiple resources and the selected passage, the relevance score indicates which of the multiple resources to output.

14. The method of claim 8 wherein processing the selected passage in accordance with the statistical analysis model comprises:
associating each of the multiple topics with a set of words to represent a concept of each of the multiple topics; and
determining a probability of relevance between the set of words and the selected passage.

15. The method of claim 8 further comprising:
reducing a number of the relevant topics through a correlation function to remove redundant concepts among the relevant topics; and
identifying the resource related to the reduced number of relevant topics.
